(19) United States
(12) Patent Application Publication
(10) Pub. No.: US 2025/0065662 A1
(43) Pub. Date: Feb. 27, 2025

(54) PRECISION-ENHANCED LASER ENGRAVING DEVICE

(71) Applicant: Laser Tools & Technics Corp., Hsin Chu City (TW)

(72) Inventors: PEI-TSE TANG, Hsin Chu City (TW); CHIEN-CHIH CHENG, Hsin Chu City (TW)

(21) Appl. No.: 18/454,079

(22) Filed: Aug. 23, 2023

(51) Int. Cl. B41M 5/26

(52) U.S. Cl. CPC B41M 5/26

(57) ABSTRACT

A precision-enhanced laser engraving device includes a working platform, which defines at least one axial direction, a laser emission port being arranged at one side of the working platform; a magnetic scale, which is arranged in the axial direction and is provided with graduations; a focusing lens set, which is movably arranged on the magnetic scale; a driver mechanism, which drives the focusing lens set to move on the magnetic scale; and a reader, which is arranged on the focusing lens set and reads the graduations of the magnetic scale to provide an instantaneous position signal. By means of a combination of the magnetic scale and the reader, the instantaneous position signal can be acquired directly from the focusing lens set to thereby eliminate an issue of errors of the driver mechanism, such as a backlash of a belt, so as to realize precise movement of a laser engraving device.

### BACKGROUND OF THE INVENTION

### (a) Technical Field of the Invention

The present invention relates to a laser engraving device, and more particularly to a laser engraving device that provides an instantaneous position signal of a focusing lens set by means of a combination of a magnetic scale and a reader.

### (b) Description of the Prior Art

A laser engraving device is a piece of equipment that applies a laser beam to implement an engraving operation on a workpiece. A laser beam of an extremely high intensity is applied to continuously irradiate a workpiece to be engraved, in order to make a portion of the workpiece reaching a melting point to realize softening downward and cutting.

Referring to FIG. 1, in a first prior art technology, a computer 100 implements data input to a controller 110, and the controller 110 transmits a command for rotation by a specific number of turns to a driver 130. The driver 130 drives a motor 140 to perform movement and identifies that the motor 140 makes rotation for the specific number of turns. Based on this, the controller 110 operates and controls a laser emission port 120 to provide a laser beam.

Referring to FIG. 2, in a second prior art technology, a computer 200 implements data input to a controller 210, and the controller 210 transmits a command for rotation by a specific number of turns to a driver 230. The driver 230 drives a motor 240 to perform movement and the driver 230 feeds data in respect of the number of turns of rotation back to the controller 210. Based on this, the controller 210 operates and controls a laser emission port 220 to provide a laser beam.

However, transmission from the motor 140 (or 240) is achieved by means of a transmission element, such as a belt. As such, an error of the transmission element, such as a backlash or other abnormality of the belt, would affect the precision of the movement.

### SUMMARY OF THE INVENTION

To achieve the purpose, the present invention provides a precision-enhanced laser engraving device, which comprises: a working platform, which defines at least one axial direction, a laser emission port being arranged at one side of the working platform; a magnetic scale, which is arranged in the axial direction and is provided with graduations; a focusing lens set, which is movably arranged on the magnetic scale; a driver mechanism, which drives the focusing lens set to move on the magnetic scale; and a reader, which is arranged on the focusing lens set and reads the graduations of the magnetic scale to provide an instantaneous position signal.

In the above device, the axial direction comprises a first axial direction, and the magnetic scale is arranged in the first axial direction.

In the above device, at least one reflection mirror is arranged between the laser emission port and the focusing lens set.

By means of the combination of the magnetic scale and the reader, the instantaneous position signal can be acquired directly from the focusing lens set to thereby eliminate an issue of errors of the driver mechanism, such as a backlash of a belt, so as to realize precise movement of a laser engraving device.

### BRIEF DESCRIPTION OF THE DRAWINGS

FIG. 1 is a block diagram illustrating a first prior art technology.

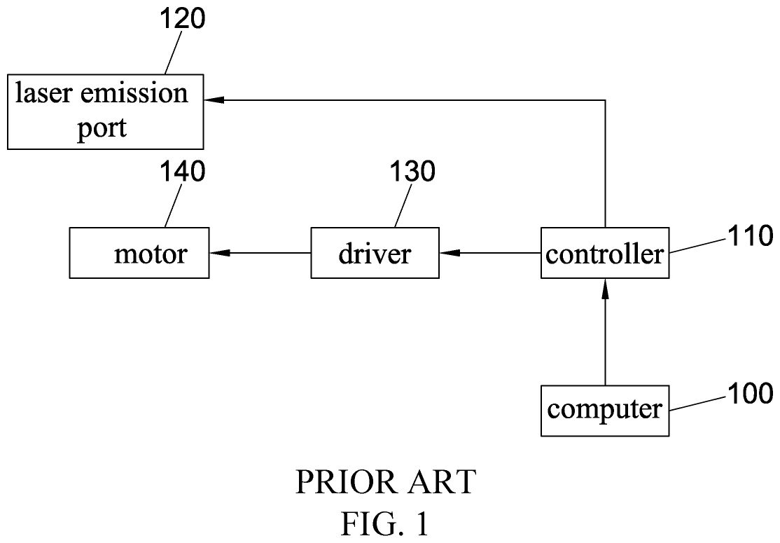

FIG. 2 is a block diagram illustrating a second prior art technology.

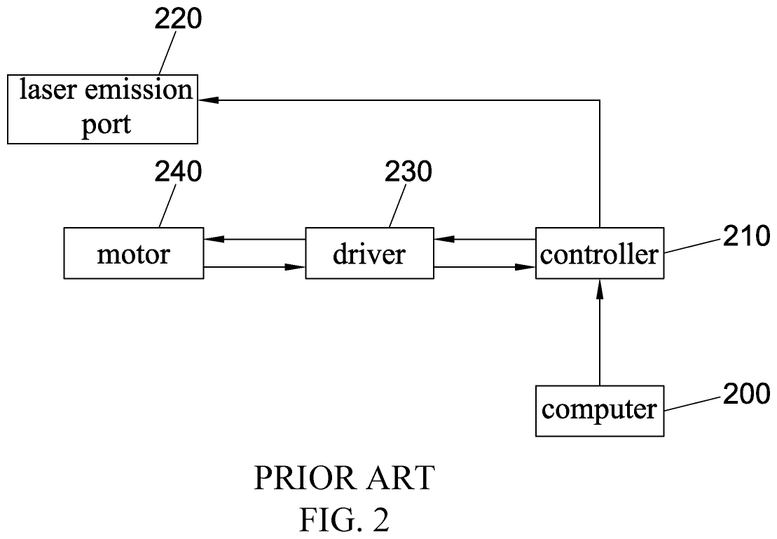

FIG. 3 is a schematic view showing a precision-enhanced laser engraving device according to the present invention.

FIG. 4 is a block diagram of the precision-enhanced laser engraving device according to the present invention.

### DETAILED DESCRIPTION OF THE PREFERRED EMBODIMENTS

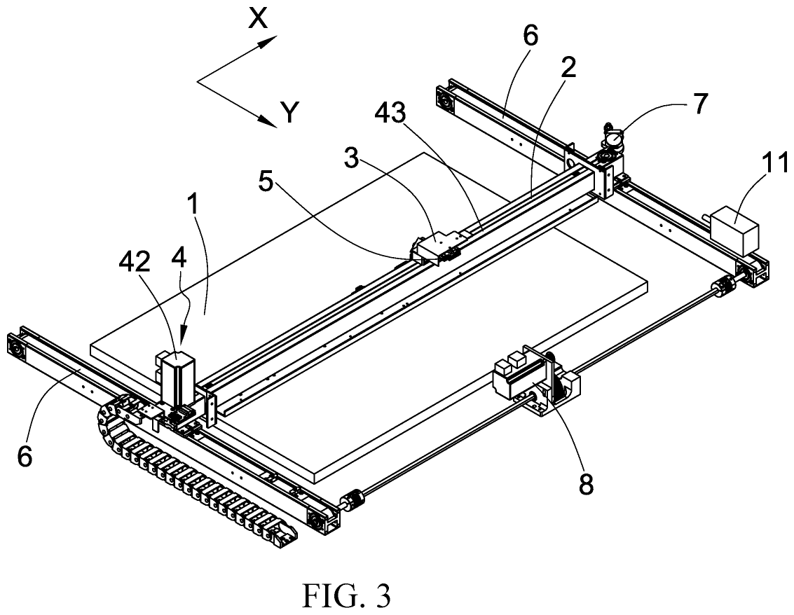

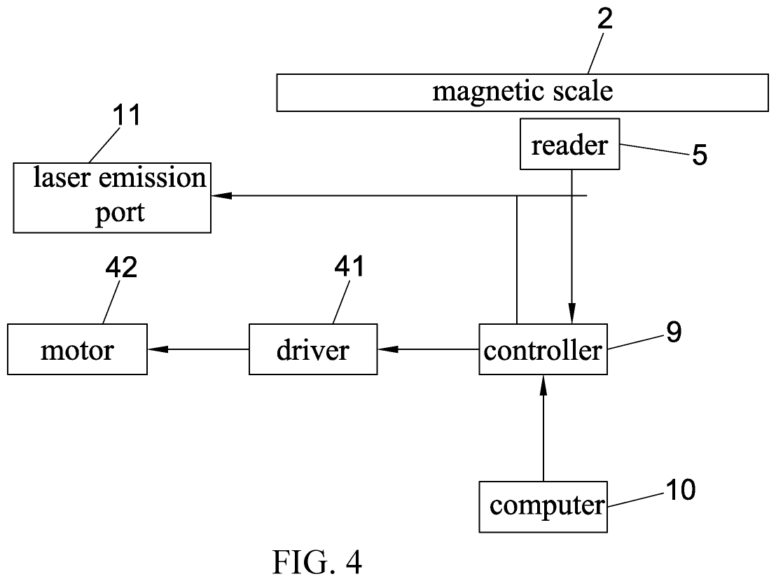

Referring to FIGS. 3 and 4, the present invention provides a precision-enhanced laser engraving device, which comprises: a working platform 1, a magnetic scale 2, a focusing lens set 3, a driver mechanism 4, and a reader 5.

The working platform 1 defines at least one axial direction, and a laser emission port 11 is arranged at one side of the working platform 1. The axial direction can be a first axial direction X (shown in FIG. 3), or the axial direction can be a second axial direction Y (shown in FIG. 3), but is not limited thereto. The first axial direction X and the second axial direction Y are perpendicular to each other. In the instant embodiment, the at least one axial direction comprises a first axial direction X and a second axial direction Y. The working platform 1 is arranged to receive a workpiece to position thereon for implementation of laser engraving. The laser emission port 11 is arranged for providing a laser beam.

The magnetic scale 2 is arranged in the axial direction, and the magnetic scale 2 is provided with graduations. The magnetic scale 2 is device that makes use of electromagnetic characteristics and magnetic recording to conduct measurement on displacement. The graduations are magnetic graduations. The magnetic scale 2 can be arranged to extend in the first axial direction X, or the magnetic scale 2 can be arranged to extend in the second axial direction Y, depending on actual need. In the instant embodiment, the magnetic scale 2 is arranged in the first axial direction X and is provided with at least one track 6. The at least one track 6 may comprise a single track or a plurality of tracks, depending on actual need. In the instant embodiment, the track 6 is arranged on each of two sides of the magnetic scale 2 to allow the magnetic scale 2 to move in the second axial direction Y.

The focusing lens set 3 is movably arranged on the magnetic scale 2. The focusing lens set 3 is arranged for focusing the laser beam provided from the laser emission port 11. At least one reflection mirror 7 is arranged between the laser emission port 11 and the focusing lens set 3, and often, there are a plurality of reflection mirrors 7. The laser beam provided from the laser emission port 11 is reflected multiple times by the plurality of the reflection mirrors 7 to then reach the focusing lens set 3.

The driver mechanism 4 drives the focusing lens set 3 to move along the magnetic scale 2. In the instant embodiment, the driver mechanism 4 is arranged to drive the focusing lens set 3 to move in the first axial direction X on the magnetic scale 2. In the instant embodiment, a moving mechanism 8 is also provided, and the moving mechanism 8 is arranged to drive the magnetic scale 2 to move along the at least one track 6 in the second axial direction Y. In the instant embodiment, the driver mechanism 4 or the moving mechanism 8 may comprise a plurality of the transmission elements. The driver mechanism 4 at least comprises a driver 41, a motor 42, and a belt 43 (wound on the track in the first axial direction X).

The reader 5 is arranged on the focusing lens set 3 and reads the graduations of the magnetic scale 2 in order to provide an instantaneous position signal. In the instant embodiment, the reader 5 applies magnetic detection to read the graduations (magnetic graduations) of the magnetic scale 2. Since the focusing lens set 3 is movable in the first axial direction X on the magnetic scale 2, the reader 5 moves with the focusing lens set 3 to read the graduations of the magnetic scale 2, so that a change of the graduations corresponds to a change of a position of the focusing lens set 3. The instantaneous position signal presents a current position of the focusing lens set 3.

Architecture and operation of the instant embodiment are described as follows:

In the architecture, the working platform 1 is arranged in a laser engraving device (not shown), and the laser emission port 11 is located at one side of the working platform 1, and the working platform 1 is taken as a reference for defining the first axial direction X and the second axial direction Y (so that movement in the first axial direction X and movement in the second axial direction Y can be used to move the focusing lens set 3 to the location of the workpiece on the working platform 1), and the at least one track 6 and the moving mechanism 8 are arranged for making the magnetic scale 2 moving in the second axial direction Y, and the driver mechanism 4 is arranged to drive the focusing lens set 3 to move in the first axial direction X on the magnetic scale 2. Referring to FIG. 4, in the operation, an operator operates a computer 10 to implement data input to a controller 9, and the controller 9 transmits the data to the driver 41, and the driver 41 instructs the driver mechanism 4 to drive the focusing lens set 3 to move in the first axial direction X on the magnetic scale 2, and the reader 5 reads the graduations of the magnetic scale 2 to provide the instantaneous position signal to the controller 9, and the controller 9 carries out calculation for positioning according to the instantaneous position signal to determine the current position of the focusing lens set 3, and then, the controller 9 operates and controls the laser emission port 11 to provide the laser beam, and the laser beam is reflected multiple times by the plurality of the reflection mirrors 7 to reach the focusing lens set 3, and the focusing lens set 3 focus the laser beam to direct to the workpiece on the working platform 1 for conducting laser engraving. Since the instantaneous position signal is directly acquired from the focusing lens set 3, an issue in respect of errors of the driver mechanism 4, such as a backlash of the belt 43, can be eliminated to thereby realize the purpose of precise movement of laser engraving device. In addition, the arrangement of the magnetic scale 2 is variable to set the magnetic scale 2 extending in the second axial direction Y.

I claim:

1. A precision-enhanced laser engraving device, comprising:
a working platform, which defines at least one axial direction, a laser emission port being arranged at one side of the working platform;
a magnetic scale, which is arranged in the axial direction and is provided with graduations;
a focusing lens set, which is movably arranged on the magnetic scale;
a driver mechanism, which drives the focusing lens set to move on the magnetic scale; and
a reader, which is arranged on the focusing lens set and reads the graduations of the magnetic scale to provide an instantaneous position signal.

2. The precision-enhanced laser engraving device according to claim 1, wherein the axial direction comprises a first axial direction, and the magnetic scale is arranged in the first axial direction.

3. The precision-enhanced laser engraving device according to claim 1, wherein at least one reflection mirror is arranged between the laser emission port and the focusing lens set.
